(19) United States
(12) Patent Application Publication
(10) Pub. No.: US 2019/0036896 A1
(43) Pub. Date: Jan. 31, 2019

(54) Generic Bootstrapping Architecture (GBA) Based Security Over Constrained Application Protocol (CoAP) for IoT Devices

(71) Applicant: Cisco Technology, Inc., San Jose, CA (US)

(72) Inventors: Ankit Khushu, San Jose, CA (US); Dusko Zgonjanin, Palo Alto, CA (US); Nam Kim, Dunwoody, GA (US)

(21) Appl. No.: 15/661,857

(22) Filed: Jul. 27, 2017

(51) Int. Cl. H04L 29/06; H04W 12/06; H04W 12/04

(52) U.S. Cl. CPC H04L 63/08; H04L 63/061; H04L 67/12; H04W 12/04; H04W 12/06

(57) ABSTRACT

Generic bootstrapping architecture (GBA) based procedures over Constrained Application Protocol (CoAP) for use in authenticating and/or securing communications with Internet of Things (IoT) devices are provided. In one illustrative example, the device sends to a bootstrapping server function (BSF) a first CoAP request carried in a Confirmable (CON) message, where the first CoAP request indicates a request for initiating a bootstrapping procedure. In response, the device receives from the BSF a first CoAP response carried in an Acknowledgement (ACK) message, where the first CoAP response indicates an authentication challenge. The device sends to the BSF a second CoAP request carried in a CON message, where the second CoAP request includes a challenge response to the authentication challenge. The device receives from the BSF a second CoAP response carried in an ACK message, where the second CoAP response includes a bootstrapping transaction identifier (B-TID) which indicates a successful authentication. The device generates a bootstrapping session key (Ks) and stores it in association with the B-TID. An HTTP messaging-based server (e.g. BSF or NAF) may utilize a module, such as a plug-in module, for message translation between CoAP and HTTP.

### TECHNICAL FIELD

The present disclosure relates generally to device authentication in communication networks, and more specifically to authenticating and securing Internet of Things (IoT) devices in communication networks.

### BACKGROUND

With the large increase in machine-to-machine (M2M) applications and the like, there is a corresponding increase in the number of low power, low throughput, low memory embedded devices (e.g. IoT devices) for various smart applications and automation processes.

Most security and authentication techniques for devices are fairly resource-intensive, however, and therefore a suitable solution to security and authentication for IoT devices has yet to be recognized.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a schematic block diagram of pertinent entities involved in performing Generic Bootstrapping Architecture (GBA) based procedures over a Constrained Application Protocol (CoAP) for use in authenticating and/or securing communications for Internet of Things (IoT) devices;

FIG. 2 is a diagram of a protocol stack for an IoT device according to some implementations;

FIG. 3 is a message flow diagram of a message flow between an IoT device, a Bootstrapping Server Function (BSF), and a Home Subscriber Server (HSS) for describing a GBA-based procedure over CoAP for use in authenticating and/or obtaining a secret key for securing communications for the IoT device according to some implementations;

FIG. 4 is a message flow diagram of a message flow between the IoT device, a Network Application Function (NAF), and the BSF for describing a GBA-based procedure over CoAP for use in authenticating and/or securing communications for the IoT device according to some implementations;

FIG. 5 is a message flow diagram of a message flow between an IoT device, the BSF, and the HSS for describing a GBA-based procedure over CoAP for use in authenticating and/or securing communications for the IoT device in an exception case according to some implementations;

FIG. 6 is a flowchart of a method of an IoT device in a GBA-based procedure over CoAP with the BSF for use in authenticating and/or securing communications for the IoT device according to some implementations;

FIG. 7 is a flowchart of a method of an IoT device in a GBA-based procedure over CoAP with the NAF for use in authenticating and/or securing communications for the IoT device according to some implementations

FIG. 8 is a flowchart of a method of a NAF in a GBA-based procedure over CoAP with an IoT device for use in authenticating and/or securing communications for the IoT device according to some implementations;

FIG. 9 is a flowchart of a method for use with a BSF and/or NAF for processing incoming messages from devices, such as IoT or M2M devices, for supporting CoAP messaging in an HTTP messaging-based server;

FIG. 10 is a flowchart of a method for use with a BSF and/or NAF for processing outgoing messages to devices, such as IoT or M2M devices, for supporting CoAP messaging in an HTTP messaging-based server;

FIG. 11 is an example of a message flow diagram with a mapping layer for mapping between CoAP and HTTP for use in translating messages;

FIG. 12 is a block diagram of an example of an Internet of Things (IoT) device of the present disclosure; and

FIG. 13 shows a block diagram of basic pertinent components of a server, such as a server comprising a BSF or NAF of the present disclosure.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION OF EXAMPLE EMBODIMENTS

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

### Overview

As described in the Background section, given the large increase in machine-to-machine (M2M) applications and the like, there is a corresponding increase in the number of low power, low throughput, low memory embedded devices (e.g. IoT devices) for various smart applications and automation processes. Most security and authentication techniques for devices are fairly resource-intensive, however, and therefore a suitable solution to security and authentication for IoT devices has not yet been recognized.

According to the present disclosure, Generic Bootstrapping Architecture (GBA) based procedures over Constrained Application Protocol (CoAP) for use in authenticating and/or securing communications for IoT or M2M devices are provided. The techniques of the present disclosure may reduce or eliminate the need for resource-intense processing and Hypertext Markup Language (HTML) protocol handling.

In one illustrative example, an IoT or M2M device is configured to perform a GBA-based procedure over CoAP with a Bootstrapping Server Function (BSF) for use in authenticating and/or obtaining a key for securing communications for the device. In the procedure, the device sends to the BSF a first CoAP request carried in a Confirmable (CON) message, where the first CoAP request indicates a request for initiating a bootstrapping procedure. In response, the device receives from the BSF a first CoAP response carried in an Acknowledgement (ACK) message, where the first CoAP response indicates an authentication challenge and information to perform an authentication (e.g. an authentication vector). The device calculates a challenge response based on the received information, and verifies it. The device sends to the BSF a second CoAP request carried in a CON message, where the second CoAP request includes the calculated challenge response. The device receives from the BSF a second CoAP response carried in an ACK message, where the second CoAP response includes a bootstrapping transaction identifier (B-TID). The receipt of the bootstrapping transaction identifier indicates a successful authentication. The device and the BSF both have a bootstrapping session key (Ks), which is stored in association with the bootstrapping transaction identifier. In some implementations, an HTTP messaging-based server comprising the BSF may utilize a module, such as a plug-in module, for message translation between CoAP and HTTP.

In another illustrative example, an IoT or M2M device is configured to perform a GBA-based procedure over CoAP with a Network Application Function (NAF) for use in authenticating and/or securing communications for the device. In the procedure, the device sends to the NAF a first CoAP request carried in a CON message, where the first CoAP request indicates a request for accessing a service from a service application. In response, the device receives from the NAF a first CoAP response carried in an ACK message, where the first CoAP response indicates that GBA bootstrapping is to be performed. In response, the device derives NAF-specific shared key material (KsNAF) from a bootstrapping session key (Ks) and a NAF identifier. The device sends to the NAF a second CoAP request carried in a CON message, where the second CoAP request indicates a request for accessing the service and includes a credential derived from the bootstrapping transaction identifier and the NAF-specific shared key material. In response, the device receives from the NAF a second CoAP response carried in an ACK message, where the second CoAP response indicates a success of the authentication and includes a response from the service application. In some implementations, an HTTP messaging-based server comprising the NAF may utilize a module, such as a plug-in module, for message translation between CoAP and HTTP.

In yet another illustrative example, a Bootstrapping Server Function (BSF) is configured to perform a GBA-based procedure over CoAP with an IoT or M2M device for use in authenticating and/or securing communications with the IoT device. In the procedure, the BSF receives from the device a first CoAP request carried in a CON message, where the first CoAP request indicates a request for initiating a bootstrapping procedure. The BSF sends to the device a first CoAP response carried in an ACK message, where the first CoAP response indicates an authentication challenge and information to perform an authentication (e.g. an authentication vector). The BSF receives from the device a second CoAP request carried in a CON message, where the second CoAP request includes a challenge response. The BSF sends to the device a second CoAP response carried in an ACK message, where the second CoAP response includes a B-TID, which indicates a successful authentication. The BSF and the device both have a bootstrapping session key (Ks), which is stored in association with the bootstrapping transaction identifier. In some implementations, an HTTP messaging-based server comprising the BSF may utilize a module, such as a plug-in module, for message translation between CoAP and HTTP.

In even another illustrative example, a NAF is configured to perform a GBA-based procedure over CoAP with an IoT or M2M device for use in authenticating and/or securing communications with the device. In the procedure, the NAF receives from the IoT device a first CoAP request carried in a CON message, where the first CoAP request indicates a request for accessing a service from a service application. In response, the NAF sends to the device a first CoAP response carried in an ACK message, where the first CoAP response indicates that GBA bootstrapping is to be performed. The NAF receives from the device a second CoAP request carried in a CON message, where the second CoAP request indicates a request for accessing the service and includes a B-TID and a credential derived from the bootstrapping transaction identifier and NAF-specific shared key material (KsNAF). The NAF sends to a BSF a request for NAF-specific shared key material and includes the B-TID and a NAF identifier, and receives from the BSF the KsNAF in response. The NAF validates the received credential using the bootstrapping transaction identifier and the NAF-specific shared key material, and sends to the device a second CoAP response carried in an ACK message, where the second CoAP response indicates whether authorization was successful. In some implementations, an HTTP messaging-based server comprising the NAF may utilize a module, such as a plug-in module, for message translation between CoAP and HTTP.

A method at a server, such as an HTTP messaging-based server (e.g. a server comprising a BSF or a NAF), is also provided. In the method, a module (e.g. a plug-in module) for message translation between CoAP messages and HTTP messages is received and installed at the server. In a GBA-based procedure or other, the server receives from a device a first CoAP request. The module of the server translates the first CoAP request into a first HTTP request. The server processes the first HTTP request to generate a first HTTP response. The module of the server translates the first HTTP response into a first CoAP response. The server sends to the device the first CoAP response. Such communication and translation may be repeated for one or more additional CoAP requests from the device.

### Example Embodiments

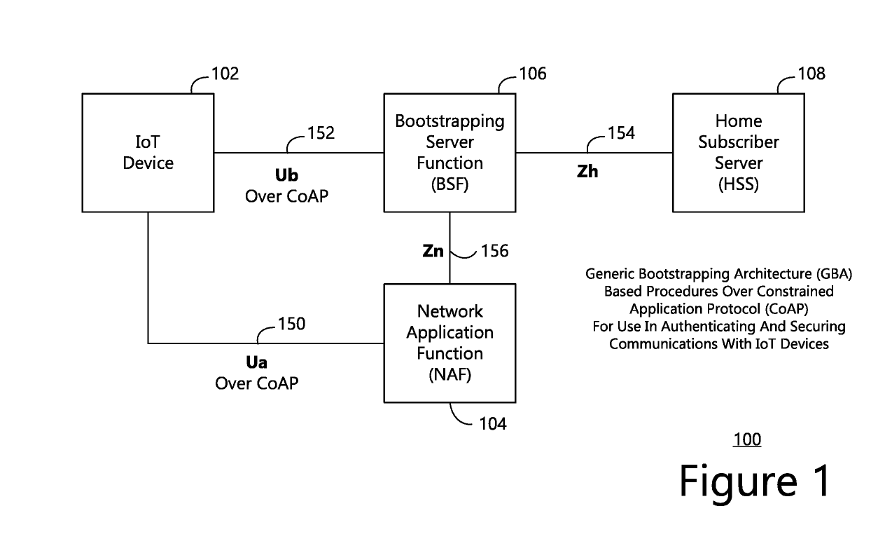

FIG. 1 is a schematic block diagram 100 of pertinent entities involved in performing Generic Bootstrapping Architecture (GBA) based procedures over a Constrained Application Protocol (CoAP) for use in authenticating and/or securing communications for Internet of Things (IoT) or Machine-To-Machine (M2M) devices. While pertinent features are illustrated in FIG. 1 and the other figures, those of ordinary skill in the art will appreciate from the present disclosure that various other features have not been illustrated for the sake of brevity and so as not to obscure more pertinent aspects of the example implementations disclosed herein.

In FIG. 1, what is shown in schematic block diagram 100 is an IoT device 102, a network application function (NAF) 104, a bootstrapping server function (BSF) 106, and a Home Subscriber Server (HSS) 108. IoT device 102, NAF 104, BSF 106, and HSS 108 employ GBA-based procedures over CoAP according to the present disclosure, for use in authenticating and/or securing communications for IoT device 102. The GBA-based procedures over CoAP according to the present disclosure may eliminate the need for resource-intense certificate processing and Hypertext Markup Language (HTML) protocol handling in IoT devices.

IoT device 102 and NAF 104 may communicate with each other over a Ua over CoAP interface 150 as described herein, whereas IoT device 102 and BSF 106 may communicate over a Ub over CoAP interface 152 as described herein. As suggested, CoAP is utilized between IoT device 102 and NAF 104 over Ua over CoAP interface 150, as well as between IoT device 102 and BSF 106 over Ub over CoAP interface 152. CoAP is a technology defined by RFC 7252. On the other hand, BSF 106 and HSS 108 may communicate each other over a Zh interface 154, whereas BSF 106 and NAF 104 may communicate with each other of a Zn interface 156.

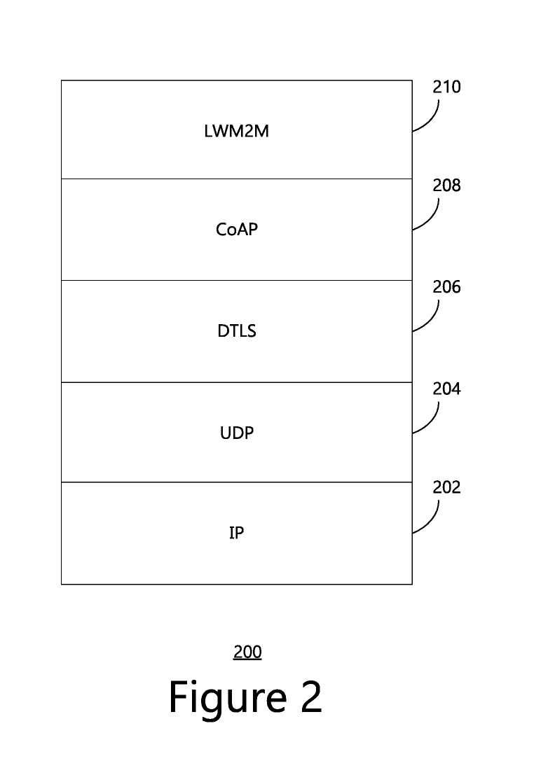

IoT device 102, NAF 104, and BSF 106 of FIG. 1 may make use of a protocol stack 200 shown in FIG. 2. Protocol stack 200 includes, from bottom to top, an Internet Protocol (IP) layer 202, a User Datagram Protocol (UDP) layer 204, a Datagram Transport Layer Security (DTLS) layer 206, a CoAP layer 208, and a Lightweight Machine To Machine (LWM2M) protocol layer 210.

Note that GBA is a technology defined by 3GPP TS 33.220 which provides for authentication of mobile phones. GBA provides for authentication by requiring that a network component challenge a smart card in a mobile phone to verify that the answer is one predicted by a Home Location Register (HLR) or HSS. GBA may be based on a shared secret between a mobile phone and a server. Initially, the mobile phone and operator are mutually authenticated through Authentication and Key Agreement (AKA) (i.e. 3GPP TS 33.102), where the entities agree on session keys subsequently used between the mobile phone and an application server. This procedure may be referred to as bootstrapping. Subsequently, services may retrieve the session keys from the operator for use in application-specific protocols between the mobile phone and the services.

As defined in TS 33.220, GBA requires the use of an HTTP client or web browser implementing digest authentication, as well as means to interface with a smart card. Specifically, for example, the Ub interface in the GBA bootstrapping procedure is required to use HTTP Digest AKA as defined in 3GPP TS 33.102.

Unfortunately, despite many advantages and potential uses of GBA, its implementation has been limited since its standardization in 2006.

The GBA-based security of the present disclosure, amongst other things, provides modifications to the GBA messaging transport to utilize CoAP. With the GBA-based security over CoAP for IoT devices according to the present disclosure, the efforts and contributions made with respect to GBA may be taken advantage of abundantly as the techniques are less resource-intensive. The GBA-based procedures over CoAP described herein may eliminate the need for resource-intense certificate processing and HTTP protocol handling in IoT devices. Further advantageously, an HTTP messaging-based server in communication with an IoT device may utilize a module, such as a plug-in module, for message translation between CoAP and HTTP.

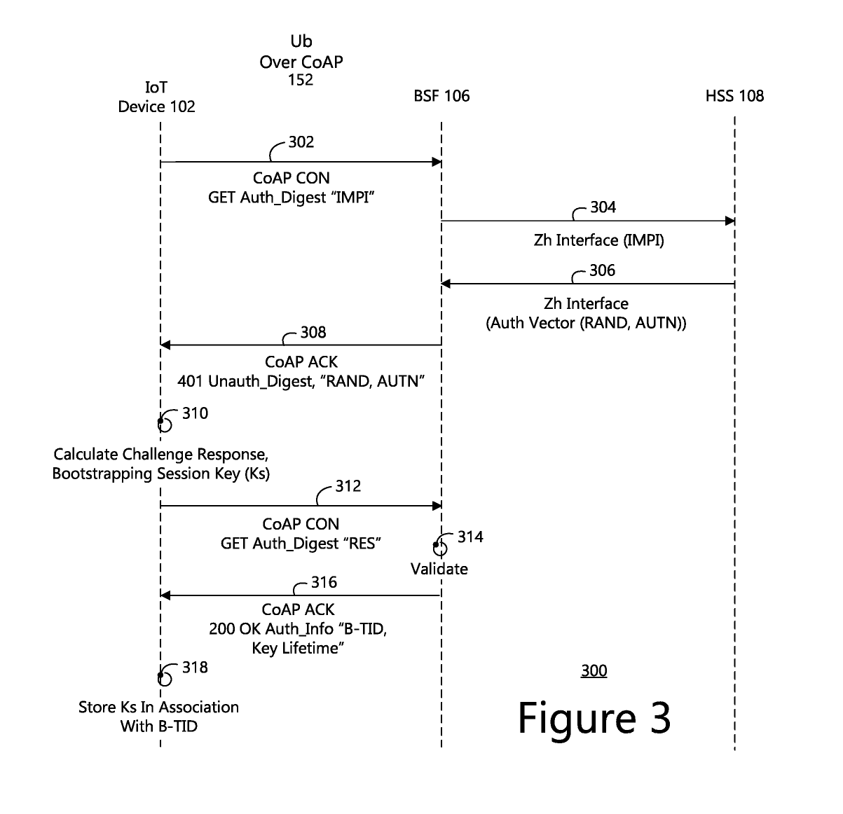

FIG. 3 is a message flow diagram 300 of a message flow between IoT or M2M device 102, BSF 106, and HSS 108, for describing a GBA-based procedure over CoAP for use in authenticating and/or securing communications for IoT device 102 according to some implementations. In this technique, IoT device 102 may communicate with BSF 106 over a Ub over CoAP interface, and BSF 106 may communicate with HSS 108 over a Zh interface.

To begin, IoT device 102 may send to BSF 106 a first CoAP request (step 302 of FIG. 3). The first CoAP request may be carried in a Confirmable (CON) message (i.e. the message may be marked as “confirmable”), and may be a GET or a PUT request. The first CoAP request may be and/or be indicative of a request for initiating a bootstrapping procedure with BSF 106. A private user identity of the device, such as an Internet Multimedia Subsystem Private Identity (IMPI), may be included in the first CoAP request.

The first CoAP request of step 302 may be received at BSF 106. In response, BSF 106 may send to HSS 108 a message including the private user identity (e.g. the IMPI) of the device (step 304 of FIG. 3). HSS 108 may receive the message from BSF 106 and, in response, may obtain an authentication vector (AV) associated with the device based on the private user identity. The authentication vector may include a random challenge (RAND) and an authentication token (AUTN). The authentication vector may also include XRES, CK, and IK parameters. HSS 108 may send to BSF 106 a message including parameters of the authentication vector (e.g. RAND and AUTN) (step 306 of FIG. 3), which is responsive to the message communicated in step 304.

The message in step 306 may be received by BSF 106. BSF 106 may then send to IoT device 102 a first CoAP response (step 308 of FIG. 3). The first CoAP response may be carried in an Acknowledgement (ACK) message, and may be responsive to the first CoAP request communicated in step 302. The first CoAP response may be or include an ACK 401 Unauthorized message.

The first CoAP response of step 308 may be and/or be indicative of an authentication challenge to the device, and/or a demand for IoT device 102 to authenticate itself. The authentication challenge may include the RAND and the AUTN.

IoT device 102 performs various calculations associated with the challenge and generates a challenge response based on the received information (step 310 of FIG. 3). For example, IoT device 102 checks AUTN to verify that the challenge is from an authorized network. If it verifies the challenge successfully, IoT device 102 calculates IK, CK, and RES parameters.

IoT device 102 may then may send to BSF 106 a second CoAP request (step 312 of FIG. 3). The second CoAP request may be carried in a CON message, and may be a GET or a PUT request. The second CoAP request may be and/or be indicative of a challenge response (i.e. the Digest AKA response) calculated using RES.

BSF 106 may receive the second CoAP request communicated in step 312. BSF 106 may then perform verifying the received Digest AKA response against the expected response (step 314 of FIG. 3). Here, BSF 106 generates a bootstrapping session key (Ks) (concatenating CK and IK), and also produces a bootstrapping transaction identifier (B-TID) associated with the Ks. BSF 106 may store the Ks in association with the B-TID.

BSF 106 sends to IoT device 102 a second CoAP response (step 316 of FIG. 3). The second CoAP response may be carried in an ACK message. When authorization is successful, the first CoAP response may be a 200 OK message. The second CoAP response may include the B-TID and a key lifetime associated with Ks. IoT device 102 generates a bootstrapping session key (Ks) based on a concatenation of CK and IK and stores the bootstrapping session key in association with the received B-TID (step 318 of FIG. 3).

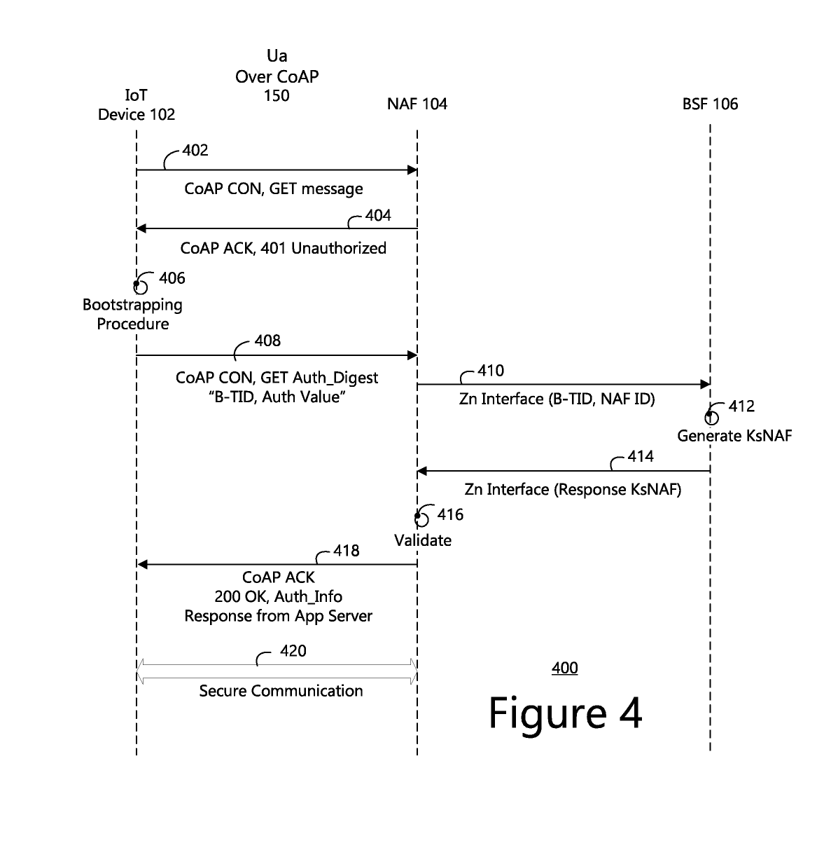

FIG. 4 is a message flow diagram 400 of a message flow between the IoT or M2M device 102, the NAF 104, and BSF 106 for describing a GBA-based procedure over CoAP for use in authenticating and/or securing communications for IoT device 102 according to some implementations. In this technique, IoT device 102 may communicate with NAF 104 over a Ua over CoAP interface, and NAF 104 may communicate with BSF 106 over a Zn interface.

To begin, IoT device 102 may send to NAF 104 a first CoAP request (step 402 of FIG. 4). The first CoAP request may be carried in a CON message (i.e. the message may be marked as “confirmable”), and may be a GET or a PUT request. The first CoAP request may be and/or be indicative of a request for initiating a service, such as a web service or the like.

NAF 104 may receive the first CoAP request communicated in step 402. In response, NAF 104 may send to IoT device 102 a first CoAP response (step 404 of FIG. 4). The first CoAP response may be carried in an ACK message. More particularly, the first CoAP response may indicate a lack of authorization, and be an ACK 401 Unauthorized message. The first CoAP response may include a NAF identifier (or NAF_id) of NAF 104.

Unless done prior to step 402, IoT device 102 may receive the first CoAP response communicated in step 404. IoT device may then perform a bootstrapping procedure with a Bootstrapping Server Function (BSF) to obtain a bootstrapping transaction identifier (B-TID) (step 406 of FIG. 4). For example, IoT device 102 may perform the bootstrapping procedure described in relation to FIG. 3. IoT device 102 may then derive NAF-specific shared key material (KsNAF) based on the B-TID and a NAF identifier. The NAF identifier may be the NAF identifier received in the first CoAP response in step 404.

IoT device 102 may send to NAF 104 a second CoAP request (step 408 of FIG. 4). The second CoAP request may be carried in a CON message, and may be a GET or a PUT request. The second CoAP request may indicate authorization information for authorization. In particular, the second CoAP request may include the B-TID and the NAF-specific shared key material (KsNAF). The second CoAP request may include the authorization values using the B-TID as a username and the NAF-specific shared key material KsNAF as a password.

NAF 104 may receive the second CoAP request communicated in step 408. In particular, NAF 104 may receive the authorization information and use it to perform validation with assistance of BSF 106. Here, NAF 104 sends to BSF 106 a message including the B-TID and the NAF identifier (step 410 of FIG. 4). BSF 106 receives this message. BSF 106 then derives the NAF-specific shared key material (KsNAF) based on the received B-TID and NAF identifier (step 412 of FIG. 4). BSF 106 then sends to NAF 104 the NAF-specific shared key material (KsNAF) (step 414 of FIG. 4).

NAF 104 receives the message including the NAF-specific shared key material communicated in step 412. NAF 104 may then perform validation (step 416 of FIG. 4), which may include verifying authorization values received from IoT device 102 with the KsNAF retrieved from BSF 106. A successful validation/authorization is based on identifying a match between the calculated values using the KsNAF and received values from IoT device 102, whereas an unsuccessful validation/authorization is based on failing to identify a match between these values.

NAF 104 may then send to IoT device 102 a second CoAP response (step 418 of FIG. 4). The second CoAP response may be carried in an ACK message, which may be responsive to the second CoAP request communicated in step 406. The second CoAP response may indicate whether the authorization was successful. When authorization is successful, for example, the second CoAP response may be a 200 OK message.

IoT device 102 may receive the second CoAP response communicated in step 416. The second CoAP response may include the payload initially requested from the device in step 402. Subsequently, data may be securely communicated between IoT device 102 and NAF 104 with use of KsNAF (step 420 of FIG. 4).

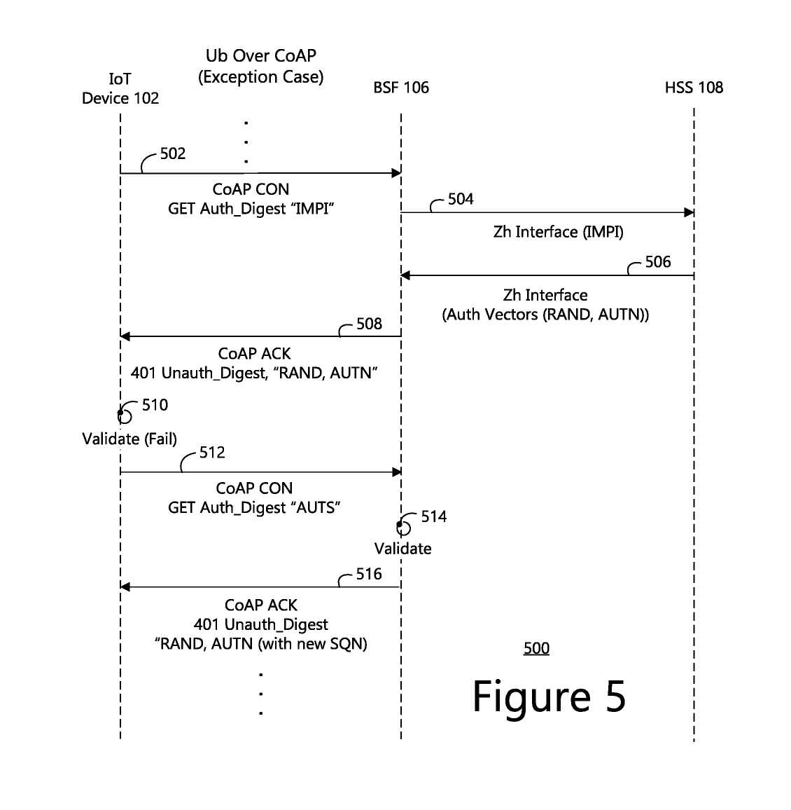

FIG. 5 is a message flow diagram 500 of a message flow between the IoT or M2M device 102, the BSF 106, and the HSS 108 for describing a GBA-based procedure over CoAP for use in authenticating and/or securing communications for IoT device 102, in an exception case, according to some implementations. IoT device 102 may communicate with BSF 106 over a Ub over CoAP interface, and BSF 106 may communicate with HSS 108 over a Zh interface.

Steps 502 through 508 of FIG. 5 may be the same as or similar to steps 302 and 308 of FIG. 3. Describing step 508 of FIG. 5, BSF 106 may send to IoT device 102 a first CoAP response carried in an ACK message. The first CoAP response of step 508 may be and/or be indicative of an authentication challenge to the device and/or a demand that IoT device 102 authenticate itself. The authentication challenge may include the random challenge (RAND) and the authentication token (AUTN).

IoT device 102 performs various calculations associated with the challenge and generates a challenge response based on the received information (step 510 of FIG. 5). For example, IoT device 102 checks AUTN to verify that the challenge is from an authorized network. If it verifies the challenge successfully, IoT device 102 calculates IK, CK, and RES parameters.

Here, IoT device 102 may fail to properly authenticate itself. For example, the authentication may fail because a sequence number in the challenge was not in the correct range or out-of-synchronization. In this case, IoT device 102 may generate a synchronization parameter (AUTS). IoT device 102 may send to BSF 106 a second CoAP request (step 512 of FIG. 5). The second CoAP request may be carried in a Confirmable (CON) message, and may be a GET or a PUT request. The second CoAP request may include the generated synchronization parameter.

BSF 106 may receive the second CoAP request communicated in step 312. BSF 106 may then perform validation based on the received synchronization parameter (AUTS) (step 514 of FIG. 5). The BSF 106 may have to retrieve from HSS 108 the corresponding AV associated with the AUTS if not available. BSF 106 may then send to IoT device 102 a second CoAP response (step 516 of FIG. 5). The second CoAP response may be carried in an ACK message, and may be or include an ACK 401 Unauthorized message.

The second CoAP response of step 516 may be and/or be indicative of another authentication challenge to the device and/or a demand for IoT device 102 to authenticate itself. The authentication challenge may include a random challenge (RAND) and an authentication token (AUTN), and further include a new sequence number (SQN). The remaining steps may be the same as or similar to those described further in relation to message flow diagram 300 of FIG. 3.

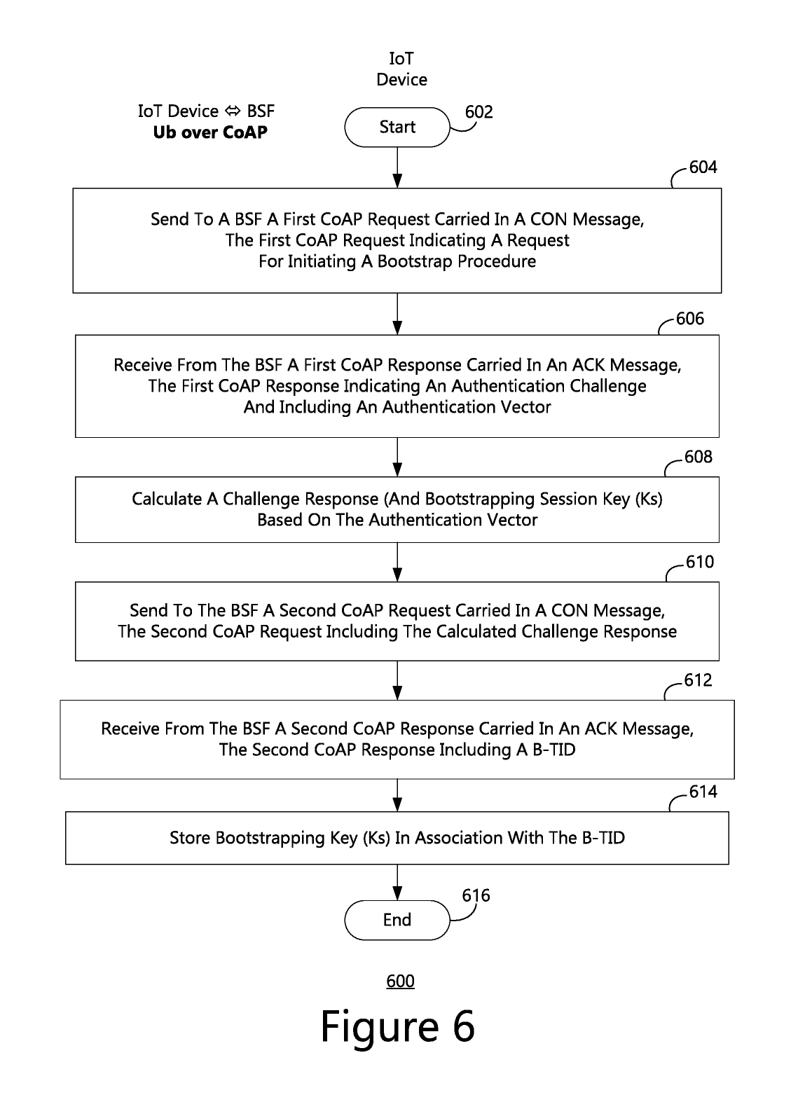

FIG. 6 is a flowchart of a method describing a Generic Bootstrapping Architecture (GBA) based procedure over Constrained Application Protocol (CoAP) for use in authenticating and/or securing communications for an IoT or M2M device according to some implementations. The method of FIG. 6 may be performed by the IoT or M2M device in association with a Bootstrapping Server Function (BSF) over a Ub over CoAP interface. The method of FIG. 6 is the same as or similar to the processing shown and described in relation to IoT or M2M device 102 in message flow diagram 300 of FIG. 3.

Beginning at a start block 602 of FIG. 6, the device may send to a BSF (e.g. a home BSF) a first CoAP request (step 604 of FIG. 6). The first CoAP request may be carried in a Confirmable (CON) message (i.e. the message may be marked as “confirmable”), and may be a GET or a PUT request. The first CoAP request may be and/or be indicative of a request for initiating a bootstrapping procedure with the BSF. A private user identity of the device, such as an Internet Multimedia Subsystem Private Identity (IMPI), may be included in the first CoAP request.

In response, the device may receive from the BSF a first CoAP response (step 606 of FIG. 6). The first CoAP response may be carried in an Acknowledgement (ACK) message. More particularly, the first CoAP response may be an ACK 401 Unauthorized message.

The first CoAP response of step 606 may be and/or be indicative of an authentication challenge to the device and/or a demand for the device to authenticate itself. The authentication challenge may include the random challenge (RAND) and the authentication token (AUTN). These authentication values may have been obtained by the BSF based on the IMPI of the device via communication with a Home Subscriber Server (HSS) over the Zh interface.

The device may perform various calculations associated with the challenge and generate a challenge response based on the received authentication information (step 608 of FIG. 6). For example, the device may check AUTN to verify that the challenge is from an authorized network. The device may calculate IK, CK, and RES parameters.

The device then may send to the BSF a second CoAP request (step 610 of FIG. 6). The second CoAP request may be carried in a CON message, and may be a GET or a PUT request. The first CoAP request may include the challenge response (i.e. the Digest AKA response) calculated using RES.

The BSF may verify the Digest AKA response. Here, the BSF generates a bootstrapping session key (Ks) and also produces a bootstrapping transaction identifier (B-TID) associated with the Ks. The BSF stores the Ks in association with the B-TID.

The device may receive from the BSF a second CoAP response (step 612 of FIG. 6). The second CoAP response may be carried in an ACK message. When authentication is successful, the first CoAP response may be a 200 OK message. The second CoAP response may include the B-TID and a key lifetime associated with Ks. The device may generate a bootstrapping session key (Ks) and store it in association with the received B-TID (step 614 of FIG. 6). The flowchart ends at an end block 616.

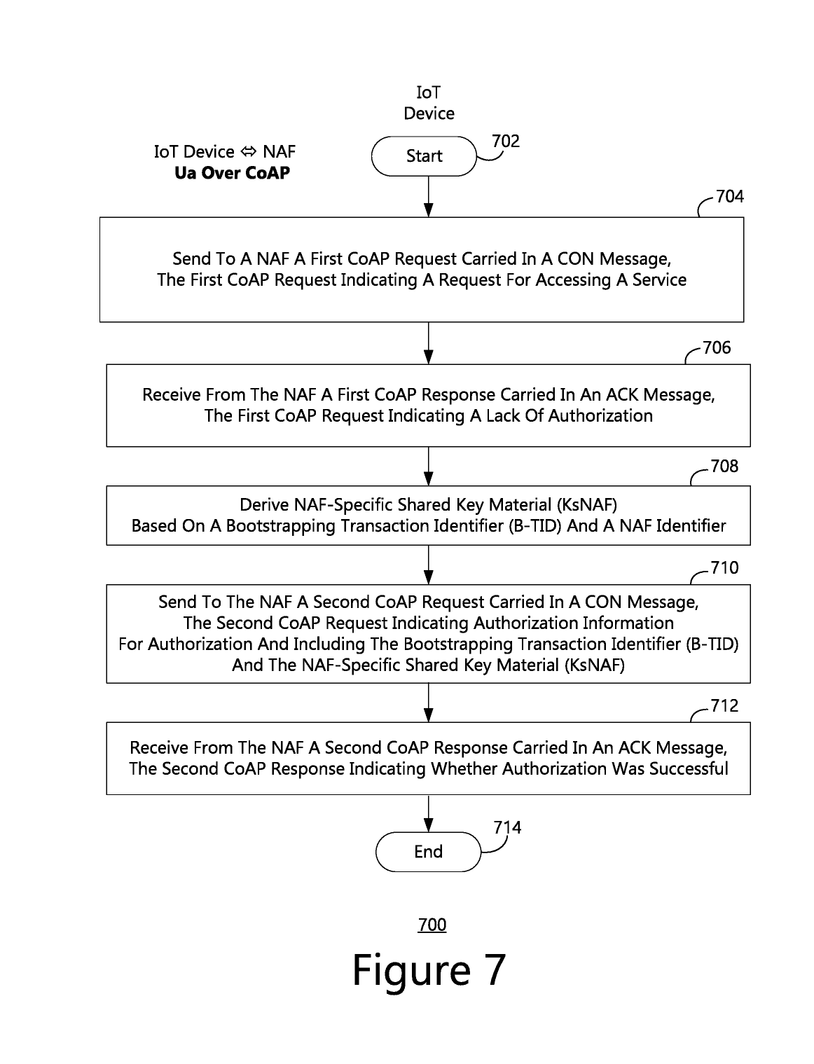

FIG. 7 is a flowchart of a method describing a GBA-based procedure over CoAP for use in authenticating and/or securing communications for an IoT or M2M device according to some implementations. The method of FIG. 7 may be performed by the IoT or M2M device in association with a Network Application Function (NAF) (or application server) over a Ua over CoAP interface. The method of FIG. 7 is the same as or similar to the processing shown and described in relation to IoT or M2M device 102 in message flow diagram 400 of FIG. 4.

Beginning at a start block 702 of FIG. 7, the device may send to a NAF a first CoAP request (step 704 of FIG. 7). The first CoAP request may be carried in a Confirmable (CON) message (i.e. the message may be marked as “confirmable”), and may be a GET or a PUT request. The first CoAP request may be and/or be indicative of a request for initiating a service, such as a web service or the like.

In response, the device may receive from the NAF a first CoAP response (step 706 of FIG. 7). The first CoAP response may be carried in an Acknowledgement (ACK) message. More particularly, the first CoAP response may indicate a lack of authorization, and be an ACK 401 Unauthorized message. The first CoAP response may include a NAF identifier (or NAF_id).

The device may derive NAF-specific shared key material (KsNAF) based on a bootstrapping transaction identifier (B-TID) and a NAF identifier (step 708 of FIG. 7). The B-TID may be the B-TID received by the device using the method described in relation to FIG. 6. The NAF identifier may be the NAF identifier received in the first CoAP response received in step 706.

The device may send to the NAF a second CoAP request (step 710 of FIG. 7). The second CoAP request may be carried in a CON message, and may be a GET or a PUT request. The second CoAP request may indicate authorization information for authorization. In particular, the second CoAP request may include the B-TID and the NAF-specific shared key material (KsNAF) derived in step 708. More particularly, the second CoAP request may include the authorization values using the B-TID as a username and the NAF-specific shared key material KsNAF as a password.

The NAF may receive the authorization information and use it to perform validation with assistance of a bootstrapping server function (BSF). The BSF may derive the KsNAF based on the B-TID and NAF identifier received from the NAF, and send the derived KsNAF to the NAF so that the NAF may verify it against the authorization values received from the device. A successful validation/authorization is based on identifying a match between the calculated values using KsNAF and received values from IoT device 102, and an unsuccessful validation/authorization is based on failing to identify a match between these values.

The device may then receive from the NAF a second CoAP response (step 712 of FIG. 7). The second CoAP response may be carried in an ACK message. The second CoAP response may indicate whether the authorization was successful. When authorization is successful, for example, the second CoAP response may be a 200 OK message. The second CoAP response may include the payload initially requested from the device in step 704. Data may be securely communicated between the device and the NAF with use of KsNAF. The flowchart ends at an end block 714.

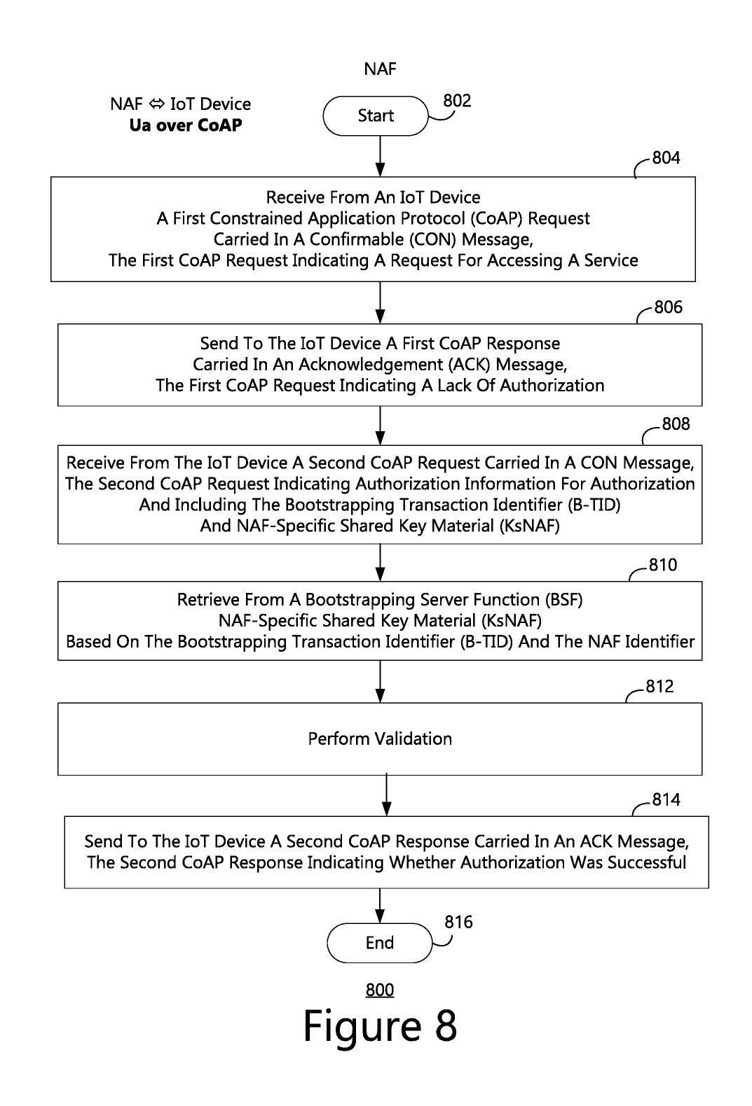

FIG. 8 is a flowchart of a method describing a GBA-based procedure over CoAP for use in authenticating and/or securing communications for an IoT or M2M device according to some implementations. The method of FIG. 8 may be performed by a network application function (NAF) or application server in association with the IoT device over a Ua over CoAP interface. The method of FIG. 8 is the same as or similar to the processing shown and described in relation to NAF 104 in message flow diagram 400 of FIG. 4.

Beginning at a start block 802 of FIG. 8, the NAF may receive from the device a first CoAP request (step 804 of FIG. 8). The first CoAP request may be carried in a Confirmable (CON) message (i.e. the message may be marked as “confirmable”), and may be a GET or a PUT request. The first CoAP request may be and/or be indicative of a request for initiating a service, such as a web service or the like.

In response, the NAF may send to the device a first CoAP response (step 806 of FIG. 8). The first CoAP response may be carried in an Acknowledgement (ACK) message. More particularly, the first CoAP response may indicate a lack of authorization, and be an ACK 401 Unauthorized message. The first CoAP response may include a NAF identifier (or NAF_id) of the NAF.

For authorization, the device may derive NAF-specific shared key material (KsNAF) based on a bootstrapping transaction identifier (B-TID) and a NAF identifier. The B-TID may be the B-TID received by the device using the method described in relation to FIG. 6. The NAF identifier may be the NAF identifier sent in the first CoAP response in step 806.

The NAF may then receive from the device a second CoAP request (step 808 of FIG. 8). The second CoAP request may be carried in a CON message, and may be a GET or a PUT request. The second CoAP request may indicate authorization information for authorization. More particularly, the second CoAP request may include the authorization values using the B-TID as a username and the NAF-specific shared key material KsNAF as a password.

The NAF uses the authorization information to perform validation with the assistance of a bootstrapping server function (BSF). Here, the NAF retrieves NAF-specific shared key material (KsNAF) from the BSF based on the B-TID and NAF identifier (step 810 of FIG. 8). The NAF then performs validation (step 812 of FIG. 8), which includes verifying the authorization values received from the device with the KsNAF retrieved from the BSF. A successful validation/authorization is based on identifying a match between the calculated values using KsNAFs, whereas an unsuccessful validation/authorization is based on failing to identify a match between these values.

The NAF may then send to the device a second CoAP response (step 814 of FIG. 8). The second CoAP response may be carried in an ACK message. The second CoAP response may indicate whether the authorization was successful. When authorization is successful, for example, the second CoAP response may be a 200 OK message. The second CoAP response may include the payload initially requested from the device in step 804. Data may be securely communicated between the device and the NAF with use of KsNAF. The flowchart ends at an end block 816.

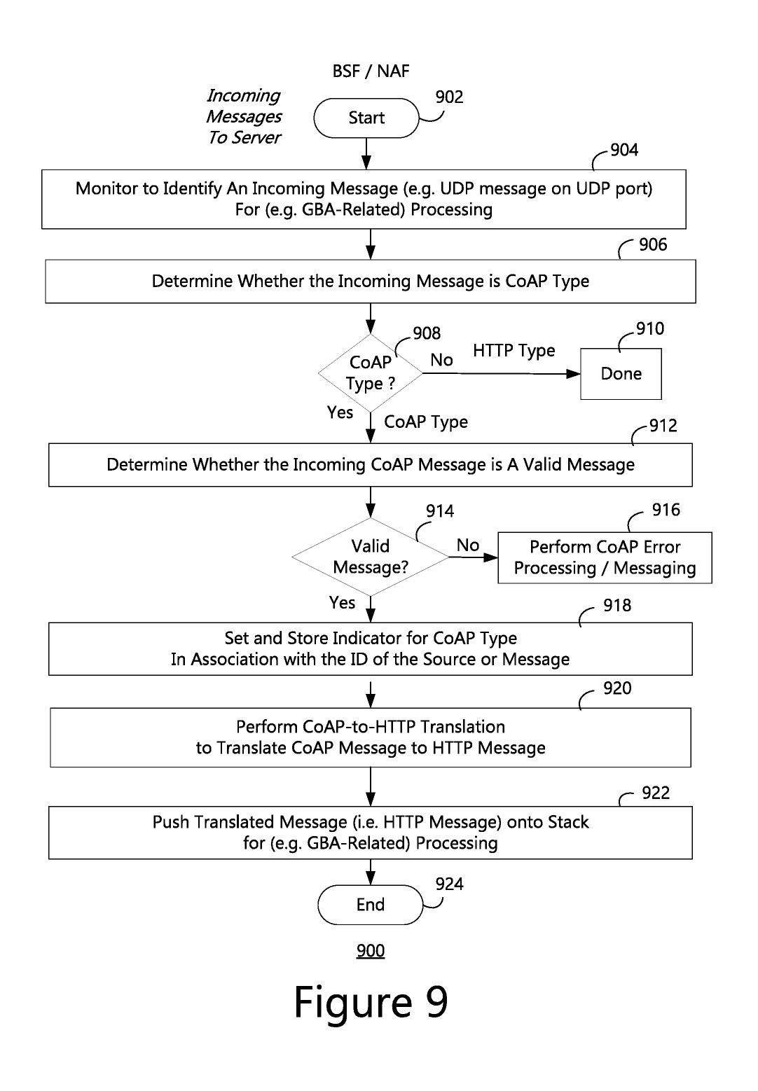

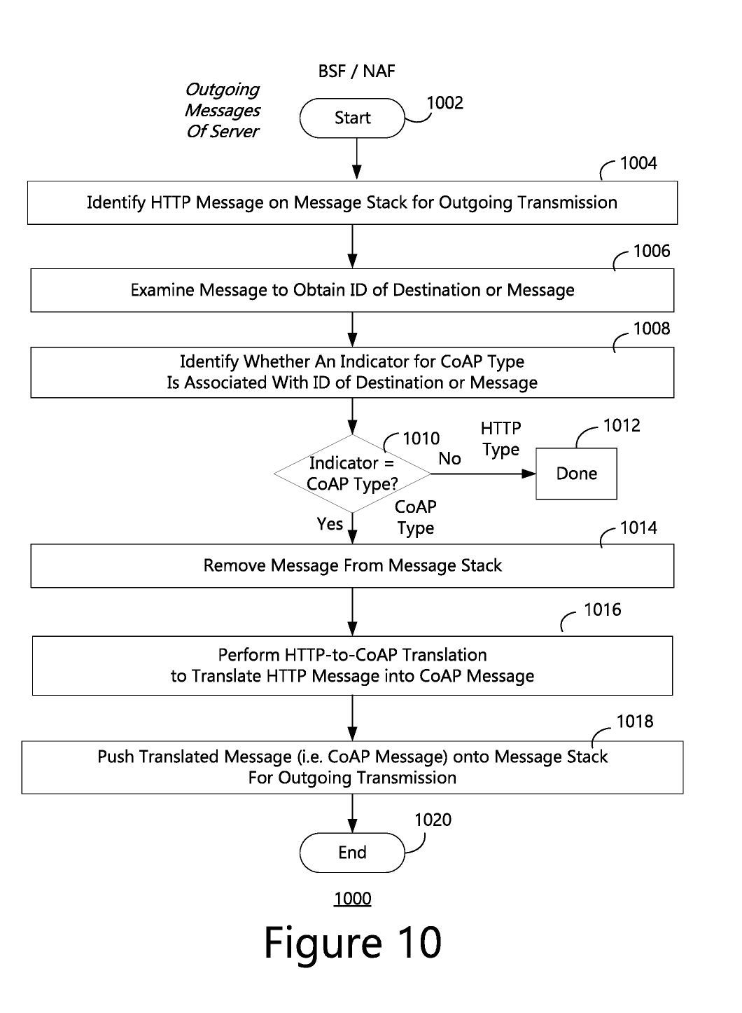

Note that today's BSFs and NAFs generally support the use of HTTP for GBA-related communication and processing. FIGS. 9 and 10 describe techniques for supporting CoAP messaging in an HTTP messaging-based server environment with use of an extension module. In some implementations, this extension module may be a plug-in module or “plug-in.” In other implementations, the method may be performed with use of software that is not a plug-in module.

FIG. 9 is a flowchart 900 of a method for use with a BSF and/or NAF (or other type server) for processing incoming messages from devices, such as IoT or M2M devices, for supporting CoAP messaging in an HTTP messaging-based server environment. The method of FIG. 9 will be described as an extension module which is or includes a plug-in module. Notably, message translation is used to translate CoAP messages to HTTP messages using a mapping layer. Prior to the method of FIG. 9, after the plug-in is installed on the server, the plug-in initially opens up one or more ports (i.e. network or UDP ports) for monitoring incoming messages.

Beginning at a start block 902, a port (e.g. a network or UDP port) is monitored to identify an incoming message (step 904 of FIG. 9). When an incoming message is identified, the incoming message is examined to determine whether it is a CoAP type (step 906 of FIG. 9). This step may be performed by examining one or more data items in one or more fields of the message and comparing them to expected data items as defined by the CoAP standard or specification. In addition or alternatively, this step may include determining whether the message is an HTTP type (e.g. if the message is determined to be an HTTP type, then it is not a CoAP type). Note that, if the message is determined to be neither a CoAP nor HTTP type, the message may be discarded.

If the incoming message is determined to be a type that is not a CoAP type (“No” branch in step 908 of FIG. 9), e.g. the message is an HTTP type, then no further processing for CoAP needs to be performed for the message (step 910 of FIG. 9). On the other hand, if the incoming message is determined to be a CoAP type (“Yes” branch in step 908 of FIG. 9), then processing continues in step 912 of FIG. 9.

Next, it is determined whether the received CoAP message is a valid message (step 912 of FIG. 9). If the received message is determined to be an invalid message (“No” branch in step 914 of FIG. 9), then CoAP error processing or error messaging is performed (step 916 of FIG. 9). Note that step 916 may involve simply discarding the message or preventing the message from being further processed by the server. If the received CoAP message is determined to be a valid message (“Yes” branch in step 914 of FIG. 9), the flowchart proceeds to step 918 of FIG. 9.

As the received message is a valid CoAP message, an indicator for CoAP type is set and stored in relation to an identifier (ID) of the source or of the message (step 918 of FIG. 9). The ID may be any suitable ID, such as a message ID or source ID. This indicator for CoAP type (e.g. ‘1’=“CoAP type”; ‘0’=“HTTP type” or “Not CoAP type”) may be used for subsequent processing of one or more subsequent (e.g. corresponding) outgoing messages from the server to the device (e.g. in relation to the method of FIG. 10).

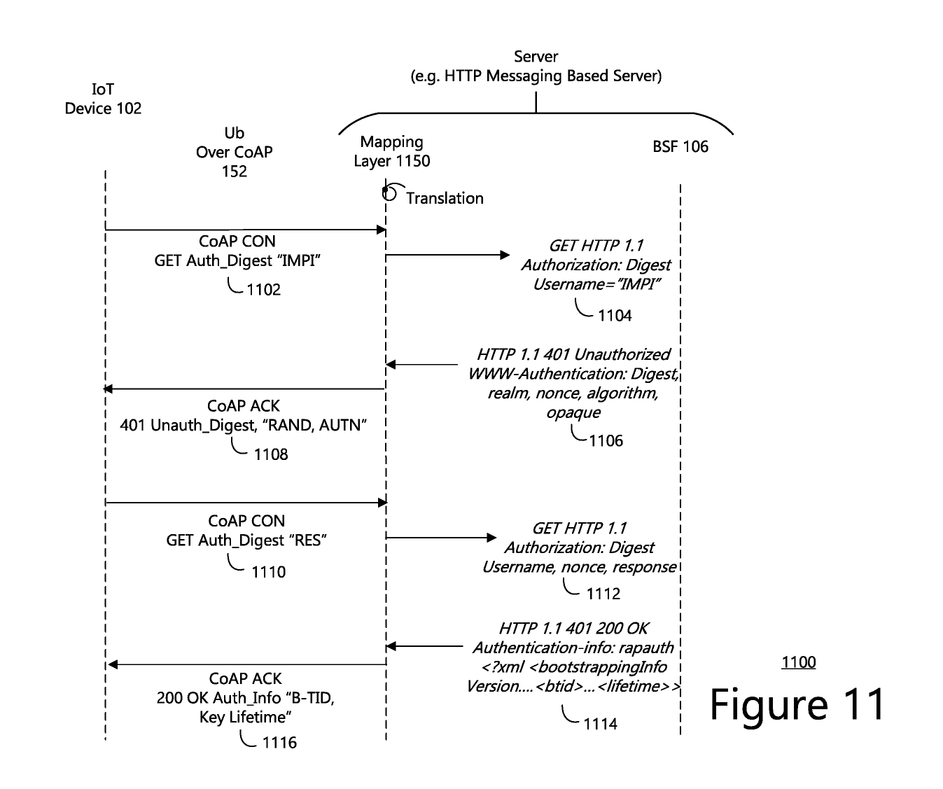

A CoAP-to-HTTP message translation is then performed to translate the CoAP message into an HTTP message (step 920 of FIG. 9). An example of such a translation with use of a mapping layer is described later below in relation to FIG. 11. The translated message (i.e. the HTTP message) is then pushed onto the message stack for (e.g. GBA-related) processing (step 922 of FIG. 9). The server processes the HTTP message as it would process other normal or conventional incoming HTTP messages. The flowchart ends at an end block 924 of FIG. 9.

FIG. 10 is a flowchart 1000 of a method for use with a BSF and/or NAF (or other type server) for processing outgoing messages to devices, such as IoT or M2M devices, for supporting CoAP messaging in an HTTP messaging-based server environment. Notably, message translation is used to translate HTTP messages to CoAP messages using a mapping layer. The method of FIG. 10 will be described as an extension module which is or includes a plug-in module.

Beginning at a start block 1002, an HTTP message on the message stack for outgoing transmission is identified (step 1004 of FIG. 10). The message is examined to obtain an ID of the destination or of the message (step 1006 of FIG. 10). Once the ID is obtained, it is identified whether an indicator for CoAP type is stored in association with the ID of the destination or of the message (step 1008 of FIG. 10). If an indicator for a type other than CoAP type is identified (“No” branch in step 1010 of FIG. 10), then no further processing for CoAP needs to be performed for the message (step 1012 of FIG. 10). On the other hand, if an indicator for CoAP type is identified (“Yes” branch in step 1010 of FIG. 10), then the message is removed from the message stack (step 1014 of FIG. 10).

An HTTP-to-CoAP message translation is then performed to translate the HTTP message into a CoAP message (step 1016 of FIG. 10). An example of such a translation with use of a mapping layer is described later below in relation to FIG. 11. The translated message (i.e. the CoAP message) is then pushed onto the message stack for outgoing transmission (step 1018 of FIG. 10). The flowchart ends at an end block 1020 of FIG. 10.

FIG. 11 is an example of a message flow diagram 1100 with a mapping layer 1150 for mapping between CoAP and HTTP, for use in translating messages for the methods described in relation to FIGS. 9 and 10. The mapping layer 1150 of FIG. 11 may be provided in an extension module, such as a plug-in, for use in an HTTP messaging-based server environment. Notably, the extension module which includes mapping layer 1150 translates incoming CoAP messages to HTTP messages (FIG. 9) and outgoing HTTP messages to CoAP messages (FIG. 10).

In the example of FIG. 11, mapping layer 1150 is for use in message translation between IoT device 102 and BSF 106 for the message flow described earlier in relation to FIG. 3. More specifically in FIG. 11, a first CoAP request 1102 from IoT device 102 is translated, by mapping layer 1150, into a (corresponding) first HTTP request 1104 for processing. The first HTTP request 1104 is processed to generate a first HTTP response 1106. The first HTTP response 1106 is translated, by mapping layer 1150, into a (corresponding) first CoAP response 1108 for transmission to IoT device 102. A second CoAP request 1110 from IoT device is translated, by mapping layer 1150, into a (corresponding) second HTTP request 1112 for processing. The second HTTP request 1112 is processed to generate a second HTTP response 1114. The second HTTP response 1114 is translated, by mapping layer 1150, into a (corresponding) second CoAP response 1116 for transmission to IoT device 102. Note that such message translation may be performed between device and server for any useful messaging therebetween.

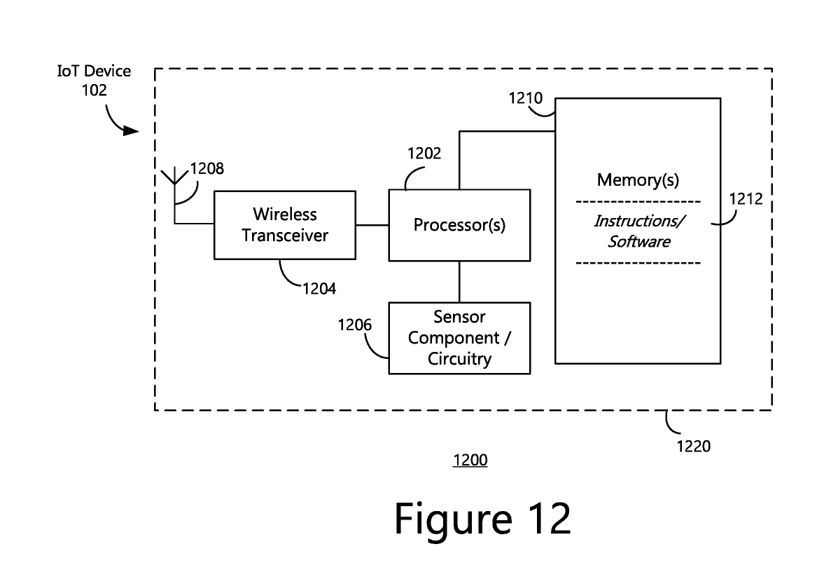

FIG. 12 is a block diagram 1200 of an example of an Internet of Things (IoT) device (e.g. IoT device 102 of FIGS. 1 and 3-5). IoT device 102 may be or include, for example, a sensor or sensor device. More particularly, IoT device 102 of FIG. 12 is shown to have components which include one or more processors 1202 and a memory 1210. The components may further include a transceiver for communications, e.g. a wireless transceiver 1204 coupled to an antenna 1208. The components of IoT device 102 may be provided together as a single unit and, for example, contained in a (e.g. mechanical) housing 1220.

Memory 1210 may store instructions/software 1212 for operation. More particularly, one or more processors 1202 are configured to operate according to the instructions 1212 in order to perform processes for conventional operation of IoT device 102, as well to perform techniques of the present disclosure. Relatedly, a computer program product may include a non-transitory computer-readable medium (e.g. memory, a computer disk, etc.) and computer instructions stored in the non-transitory computer-readable medium that, when executed by one or more processors, may perform the described techniques.

One or more processors 1202 are configured to operate wireless transceiver 1204 to provide wireless communications in accordance with a communication protocol or standard. The communication protocol or standard adhered to by wireless transceiver 1204 and/or one or more processors 1202 may be e.g. IEEE 802.15 for communications in wireless personal area networks (WPANs) or the like. In addition, one or more processors 1202 may operate to communicate signals to and/or from a sensor component/circuitry 1206 for appropriate processing.

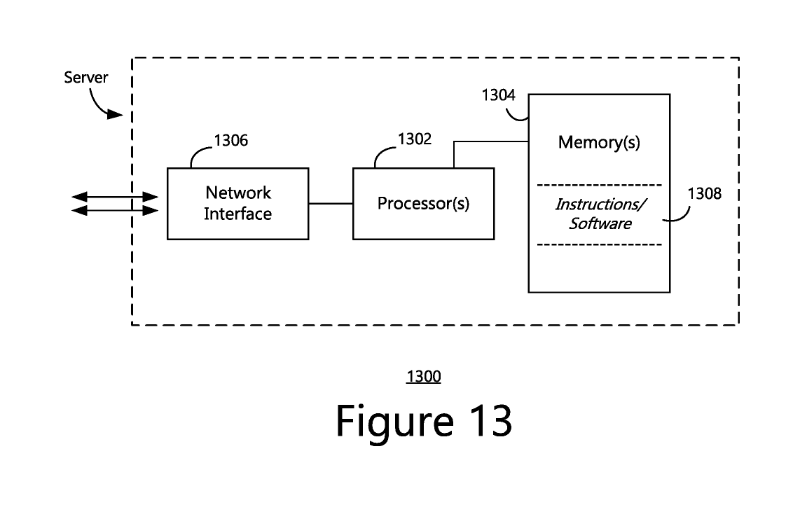

FIG. 13 shows a block diagram 1300 of basic pertinent components of a server, such as a server comprising a BSF or NAF (e.g. BSF 106 or NAF 104 of FIGS. 1 and 3-5). The server of FIG. 13 has components which may include one or more processors 1302 which are coupled to memory 1304 and to a network interface 1306. Network interface 1306 is configured to connect to a communication network for communications. The one or more processors 1302 of the server are configured to operate according to instructions 1308 stored in memory 1304, in order to perform basic operations as well as to perform techniques of the present disclosure.

Thus, Generic Bootstrapping Architecture (GBA) based procedures over Constrained Application Protocol (CoAP) for use in authenticating and/or securing communications for IoT devices are provided. The techniques of the present disclosure may reduce or eliminate the need for resource-intense processing and Hypertext Markup Language (HTML) protocol handling.

In one illustrative example, an IoT or M2M device is configured to perform a GBA-based procedure over CoAP with a Bootstrapping Server Function (BSF) for use in authenticating and/or obtaining a key for securing communications for the IoT device. In the procedure, the device sends to the BSF a first CoAP request carried in a Confirmable (CON) message, where the first CoAP request indicates a request for initiating a bootstrapping procedure. In response, the device receives from the BSF a first CoAP response carried in an Acknowledgement (ACK) message, where the first CoAP response indicates an authentication challenge and information to perform an authentication (e.g. an authentication vector). The device calculates a challenge response based on the received information, and verifies it. The device sends to the BSF a second CoAP request carried in a CON message, where the second CoAP request includes the calculated challenge response. The device receives from the BSF a second CoAP response carried in an ACK message, where the second CoAP response includes a bootstrapping transaction identifier (B-TID). The receipt of the bootstrapping transaction identifier indicates a successful authentication. The device and the BSF both have a bootstrapping session key (Ks), which is stored in association with the bootstrapping transaction identifier. In some implementations, an HTTP messaging-based server comprising the BSF may utilize a module, such as a plug-in module, for message translation between CoAP and HTTP.

In another illustrative example, an IoT or M2M device is configured to perform a GBA-based procedure over CoAP with a Network Application Function (NAF) for use in authenticating and/or securing communications for the IoT device. In the procedure, the device sends to the NAF a first CoAP request carried in a CON message, where the first CoAP request indicates a request for accessing a service from a service application. In response, the device receives from the NAF a first CoAP response carried in an ACK message, where the first CoAP response indicates that GBA bootstrapping is to be performed. In response, the device derives NAF-specific shared key material (KsNAF) from a bootstrapping session key (Ks) and a NAF identifier. The device sends to the NAF a second CoAP request carried in a CON message, where the second CoAP request indicates a request for accessing the service and includes a credential derived from the bootstrapping transaction identifier and the NAF-specific shared key material. In response, the device receives from the NAF a second CoAP response carried in an ACK message, where the second CoAP response indicates a success of the authentication and includes a response from the service application. In some implementations, an HTTP messaging-based server comprising the NAF may utilize a module, such as a plug-in module, for message translation between CoAP and HTTP.

A device, such as an IoT device or M2M device, may include a wireless transceiver and one or more processors coupled to the wireless transceiver, where the one or more processors are configured to communicate via the transceiver to perform the IoT device methods described herein. A computer program product may comprise a non-transitory computer readable medium and instructions stored on the non-transitory computer readable medium, where the instructions are executable on one or more processors of the IoT device to perform the IoT device methods described herein.

In yet another illustrative example, a Bootstrapping Server Function (BSF) is configured to perform a GBA-based procedure over CoAP with an IoT or M2M device for use in authenticating and/or securing communications with the IoT device. In the procedure, the BSF receives from the device a first Constrained Application Protocol (CoAP) request carried in a Confirmable (CON) message, where the first CoAP request indicates a request for initiating a bootstrapping procedure. The BSF sends to the device a first CoAP response carried in an Acknowledgement (ACK) message, where the first CoAP response indicates an authentication challenge and information to perform an authentication (e.g. an authentication vector). The BSF receives from the device a second CoAP request carried in a CON message, where the second CoAP request includes a challenge response. The BSF sends to the device a second CoAP response carried in an ACK message, where the second CoAP response includes a bootstrapping transaction identifier (B-TID), which indicates a successful authentication. The BSF and the device both have a bootstrapping session key (Ks), which is stored in association with the bootstrapping transaction identifier. In some implementations, an HTTP messaging-based server comprising the BSF may utilize a module, such as a plug-in module, for message translation between CoAP and HTTP.

In even another illustrative example, a NAF is configured to perform a GBA-based procedure over CoAP with an IoT or M2M device for use in authenticating and/or securing communications with the IoT device. In the procedure, the NAF receives from the IoT device a first CoAP request carried in a CON message, where the first CoAP request indicates a request for accessing a service from a service application. In response, the NAF sends to the device a first CoAP response carried in an ACK message, where the first CoAP response indicates that GBA bootstrapping is to be performed. The NAF receives from the device a second CoAP request carried in a CON message, where the second CoAP request indicates a request for accessing the service and includes a bootstrapping transaction identifier (B-TID) and a credential derived from the bootstrapping transaction identifier and NAF-specific shared key material (KsNAF). The NAF sends to a BSF a request for NAF-specific shared key material and includes the B-TID and a NAF identifier, and receives from the BSF the KsNAF in response. The NAF validates the received credential using the bootstrapping transaction identifier and the NAF-specific shared key material, and sends to the device a second CoAP response carried in an ACK message, where the second CoAP response indicates whether authorization was successful. In some implementations, an HTTP messaging-based server comprising the NAF may utilize a module, such as a plug-in module, for message translation between CoAP and HTTP.

An additional method at a server, such as an HTTP messaging-based server (e.g. a server comprising a BSF or a NAF), is also provided. In the method, a module (e.g. a plug-in module) for message translation between CoAP messages and HTTP messages is received and installed at the server. The server receives from a device a first CoAP request. The module of the server translates the first CoAP request into a first HTTP request. The server processes the first HTTP request to generate a first HTTP response. The module of the server translates the first HTTP response into a first CoAP response. The server sends to the device the first CoAP response.

A server, such as a server comprising a NAF or a BSF, may include one or more processors and a network interface coupled to the one or more processors, where the network interface is configured for interfacing with a network, and where the one or more processors are configured to perform the server methods described herein. A computer program product may comprise a non-transitory computer readable medium and instructions stored on the non-transitory computer readable medium, where the instructions being executable on one or more processors of the server to perform the server methods described herein.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, which changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1. A method comprising:
at a device,
sending to a bootstrapping server function (BSF) a first Constrained Application Protocol (CoAP) request, the first CoAP request indicating a request for initiating a bootstrapping procedure;
receiving from the BSF a first CoAP response, the first CoAP response indicating an authentication challenge;
sending to the BSF a second CoAP request, the second CoAP request including a challenge response to the authentication challenge; and
receiving from the BSF a second CoAP response, the second CoAP response including a bootstrapping transaction identifier associated with a bootstrapping session key.

2. The method of claim 1, further comprising:
wherein the first and the second CoAP requests are carried in Confirmable messages, and
wherein the first and the second CoAP responses are carried in Acknowledgement messages.

3. The method of claim 1, further comprising:
deriving the bootstrapping session key; and
storing the bootstrapping transaction identifier in association with the derived bootstrapping session key.

4. The method of claim 1, wherein the first CoAP response includes a random challenge (RAND) and an authentication token (AUTN).

5. The method of claim 1, wherein the first CoAP response indicating the authentication challenge comprises an ACK 401 Unauthorized message.

6. The method of claim 1, wherein the device comprises an Internet of Things (IoT) device or a machine-to-machine (M2M) device.

7. The method of claim 1, further comprising:
at an HTTP messaging based server comprising the BSF,
executing a plug-in module for message translation between CoAP and HTTP.

8. A device comprising:
a wireless transceiver; and
one or more processors coupled to the wireless transceiver, the one or more processors being configured to communicate via the wireless transceiver to:
send to a bootstrapping server function (BSF) a first Constrained Application Protocol (CoAP) request, the first CoAP request indicating a request for initiating a bootstrapping procedure;
receive from the BSF a first CoAP response, the first CoAP response indicating an authentication challenge;
send to the BSF a second CoAP request, the second CoAP request indicating a challenge response to the authentication challenge; and
receive from the BSF a second CoAP response, the second CoAP response including a bootstrapping transaction identifier associated with a bootstrapping key.

9. The device of claim 8, further comprising:
wherein the first and the second CoAP requests are carried in Confirmable messages, and
wherein the first and the second CoAP responses are carried in Acknowledgement messages.

10. The device of claim 8, wherein the one or more processors are further configured to communicate via the wireless transceiver to:
derive the bootstrapping key; and
storing the bootstrapping transaction identifier in association with the derived bootstrapping key.

11. The device of claim 8, wherein the first CoAP response includes a random challenge (RAND) and an authentication token (AUTN).

12. A method comprising:
at a server comprising a Network Application Function (NAF),
receiving, from a device, a first Constrained Application Protocol (CoAP) request, the first CoAP request indicating a request for accessing a service from a service application;
sending, to the device, a first CoAP response, the first CoAP response indicating that General Bootstrapping Architecture (GBA) bootstrapping is to be performed;
receiving, from the device, a second CoAP request, the second CoAP request indicating a request for accessing the service and including a bootstrapping transaction identifier (B-TID) and a credential derived from the B-TID and NAF-specific shared key material (KsNAF);
sending, to a Bootstrapping Server Function (BSF), a request for KsNAF and including the B-TID and a NAF identifier of the NAF; and
receiving, from the BSF, the KsNAF in response.

13. The method of claim 12, further comprising:
performing validation of the received credential using the B-TID and the KsNAF; and
sending, to the device, a second CoAP response, the second CoAP response indicating whether authorization was successful.

14. The method of claim 12, further comprising:
wherein the first and the second CoAP requests are carried in Confirmable messages, and
wherein the first and the second CoAP responses are carried in Acknowledgement messages.

15. The method of claim 14, further comprising:
translating the first CoAP request into a first HTTP request;
processing the first HTTP request to generate a first HTTP response; and
translating the first HTTP response into the first CoAP response.

16. The method of claim 15, further comprising:
executing a plug-in module for message translation between CoAP and HTTP.

17. The method of claim 15, wherein the steps of translating are performed by a plug-in module of the server.

18. The method of claim 12, wherein the server comprises a Bootstrapping Server Function (BSF) or a Network Application function (NAF).

19. The method of claim 18, wherein the device comprises an Internet of Things (IoT) device or a Machine-to-Machine (M2M) communications device.
